(19) United States
(12) Patent Application Publication
(10) Pub. No.: US 2007/0040897 A1
(43) Pub. Date: Feb. 22, 2007

(54) Video communication apparatus and video communication method

(76) Inventors: Hiroshi Kawada, Tachikawa-shi (JP); Noriya Sakamoto, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/442,586

(22) Filed: May 30, 2006

(30) Foreign Application Priority Data
May 31, 2005 (JP) 2005-160348

(51) Int. Cl. H04N 7/14

(52) U.S. Cl. 348/14.07

(57) ABSTRACT

According to one embodiment, a video communication apparatus comprising communication unit which performs communication with an external device, tuner unit which receives broadcasting signals, first codec and second codec which receive and decode video/audio signals and output the decoded signals, display unit which receives the decoded signals, and control unit which controls so as, when one of the codecs is designated and an instruction to perform video communications with the external device is received, or, one of the codecs is designated and an instruction to perform a process of decoding video/audio signals of broadcasting signals, to perform the instructed process by the designated codec, and when the designated codec is already being used, to perform the instructed process by use of the codec that is not being used, and display message to the effect that the other codec is being used.

### CROSS-REFERENCE TO RELATED APPLICATIONS

This application is based upon and claims the benefit of priority from Japanese Patent Application No. 2005-160348, filed May 31, 2005, the entire contents of which are incorporated herein by reference.

### BACKGROUND

1. Field

One embodiment of the invention relates to a video communication apparatus using a codec such as MPEG (Moving Picture Experts Group), and more specifically, to a video communication apparatus and a video communication method using a plurality of codecs.

2. Description of the Related Art

In recent years, along the progress and spread of digital technologies and digital apparatuses, video communication apparatuses having plural functions have been developed and manufactured. As examples thereof, there are known video phones, etc. that packetize video/audio signals and thereby perform communications via a network.

Patent Document 1 (Jpn. Pat. Appln. KOKAI Publication No. 4-160853) discloses an example of a video phone that uses a video coding/decoding unit and performs communications with external devices via a network.

However, in a video phone and a video conference system presented by the prior art disclosed in the Patent Document 1, only one unit of video coding/encoding unit as a codec is shown. Any other process to be performed with video phone communications in a same casing, for example, a process of receiving broadcasting signals and performing browsing on a same display is not shown. In such a case, any description is not shown on how to appropriately handle plural codecs in the case when plural codes are prepared, which has been a problem with the prior art.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an example of a configuration of a video communication apparatus according to an embodiment of the present invention;

FIG. 2 is an external view showing an example of an external appearance of the video communication apparatus according to the embodiment of the invention;

FIG. 3 is an explanatory diagram showing an example of a relation between video processes and codecs in the video communication apparatus according to the embodiment of the invention;

FIG. 4 is a flowchart showing an example of a process of selecting a codec in making a video phone call in MPEG-4 in the video communication apparatus according to the embodiment of the invention;

FIG. 5 is a flowchart showing an example of a process of selecting a codec in making a video phone call in MPEG-2 in the video communication apparatus according to the embodiment of the invention;

FIG. 6 is a view showing an example of a message screen to be displayed in making a video phone call in MPEG-2 or MPEG-4 in the video communication apparatus according to the embodiment of the invention;

FIG. 7 is a flowchart showing an example of a process of selecting a codec in making a video phone call in MPEG-4 in consideration of reservation conditions in the video communication apparatus according to the embodiment of the invention;

FIG. 8 is a view showing an example of a message screen to be displayed in making a video phone call in MPEG-4 in consideration of reservation conditions in the video communication apparatus according to the embodiment of the invention;

FIG. 9 is a flowchart showing an example of a process of selecting a codec in making a video phone call in MPEG-2 in consideration of reservation conditions in the video communication apparatus according to the embodiment of the invention;

FIG. 10 is a view showing an example of a message screen to be displayed in making a video phone call in MPEG-2 in consideration of reservation conditions in the video communication apparatus according to the embodiment of the invention; and

FIG. 11 is a block diagram showing another example of the configuration of the video communication apparatus according to the embodiment of the invention.

### DETAILED DESCRIPTION

Various embodiments according to the invention will be described hereinafter with reference to the accompanying drawings. In general, according to one embodiment of the invention, a video communication apparatus comprising: a display unit which receives decoded signals from at least one of a first codec and a second codec and displays video corresponding to the signals; and a control unit which performs a control so as to designate one of the first codec and the second codec and receive an instruction to perform video communications by video/audio signals with an external device by use of a communication unit, or, designate one of the first codec and the second codec and receive an instruction to perform a process of decoding video/audio signals of broadcasting signals by use of a tuner unit; and perform the instructed process by the designated codec of the first codec and the second codec; and in the case where the designated codec is already being used, perform the instructed process by use of the codec that is not being used, and display a message to the effect that the other codec than the designated one is being used.

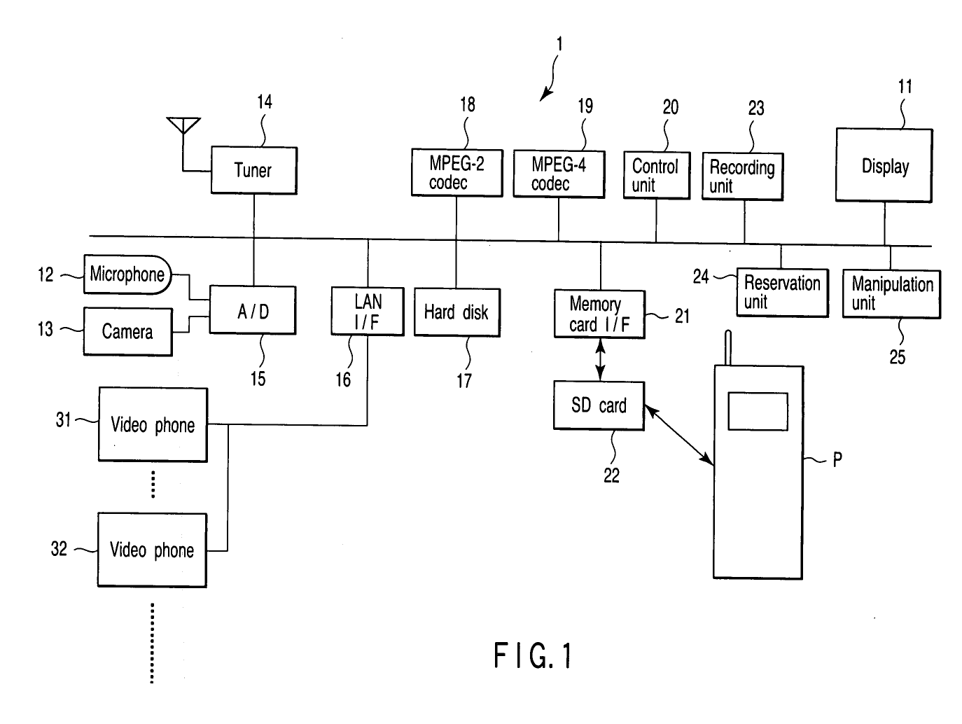

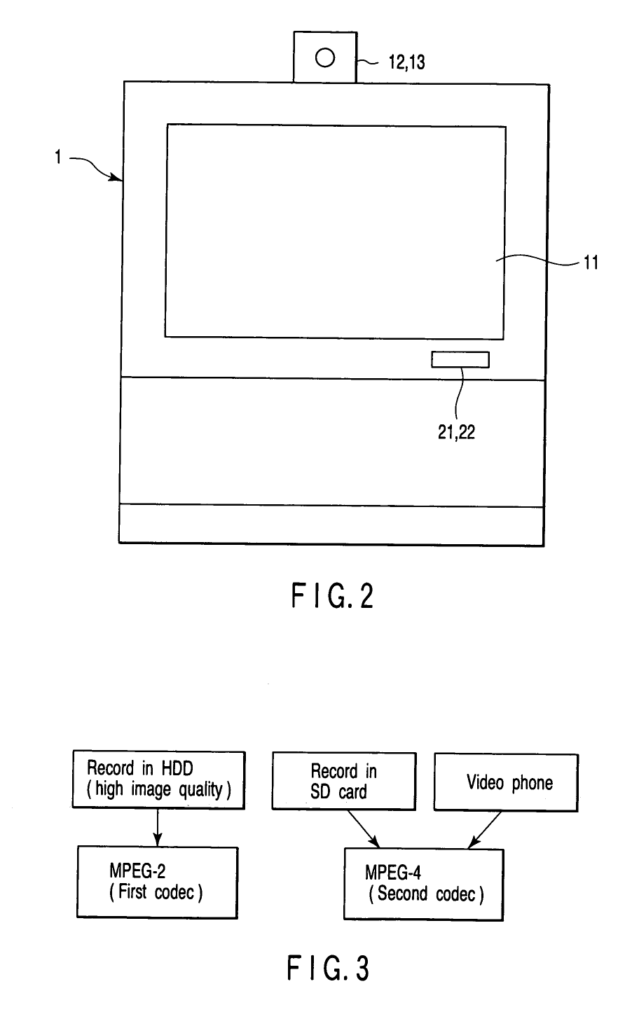

Now, embodiments of the present invention will be illustrated in more details with reference to the accompanying drawings. FIG. 1 is a block diagram showing an example of a configuration of a video communication apparatus according to an embodiment of the present invention. FIG. 2 is an external view showing an example of an external appearance of the video communication apparatus according to the embodiment of the invention.

<Video Communication Apparatus as an Embodiment of the Present Invention>

(Configuration)

A video communication apparatus as an embodiment of the present invention will be illustrated in more details with reference to the accompanying drawings hereinafter. The video communication apparatus 1 as an embodiment of the invention has at least a video phone function of performing communications with an electronic device having a video phone function as an external device via a network, and a TV function of receiving digital broadcasting and the like and displaying video of broadcasting signals.

The video communication apparatus 1 includes: a control unit 20 that controls the entire operation; a tuner unit 14 that receives and demodulates broadcasting signals; an A/D converter 15 to which a microphone 12 and a camera unit 13 connected from outside are connected; a LAN_I/F 16 to which video phones 31, 32 of external network information are connected; a hard disk 17 that records video/audio signals and the like from the tuner unit 14; and an MPEG-2 codec 18 and an MPEG-4 codec 19 that decode video signals from the tuner unit 14 or video signals from the LAN_I/F 16, and code video signals from the camera unit 13 and the like.

Further, the video communication apparatus 1 as the embodiment of the invention includes: a recording unit 23 that records an operation program and the like; a reservation unit 24 that performs timer recording and the like of the tuner unit 14; a manipulation unit 25 that converts user's manipulation into manipulation signals through a remote controller or switches on a manipulation panel; a memory card I/F 21; an SD card 22 as a detachable recording medium to which the memory card I/F 21 is connected; and a display 11 that displays video corresponding to video signals processed by the MPEG-2 codec 18 and the MPEG-4 codec 19.

Furthermore, the above SD card 22 is inserted into, for example, a cell phone P, whereby broadcasting video and the like can be watched on the cell phone P. These components are connected to the control unit 20 that controls the entire operation via a cable and the line respectively.

(Function)

Such a video communication apparatus 1 has its external appearance as shown in FIG. 2 as an example, and for example, the microphone 12 and the camera unit 13 are connected and arranged onto the top of the main body. Thereby, the video communication apparatus 1 has a broadcasting receiving function as a general television apparatus for receiving terrestrial, terrestrial digital, BS analog, BS digital, CS digital and the like. Further, the video communication apparatus 1 can record video signals of the television broadcasting and reproduce them for viewing. Further, the video communication apparatus 1 records these video signals into a detachable memory card and the like, and also functions as a video phone by use of the microphone 12 and the camera unit 13.

Namely, in the broadcasting receiving function of such a video communication apparatus 1, broadcasting signals obtained from an antenna or the like are received by the tuner unit 14 and demodulated and output as video/audio signals under the control of the control unit 20. Further, the video/audio signals are decoded by the MPEG-2 codec 18 or the MPEG-4 codec 19, and displayed as reproducible video/audio signals on the display 11. Or, the decoded video/audio signals may be recorded into the hard disk 17 and the like, and then reproduced arbitrarily later under the control of the control unit 20. Furthermore, according to reservation information arbitrarily set by the user by the reservation unit 24, timer recording may be performed into the hard disk 17 and the like. Moreover, the reproducible video/audio signals may be made into files, and recorded into a detachable recording medium such as the SD card 22 and the like via the memory card I/F 21. Further, video/audio signal files stored into the SD card and the like may be reproduced arbitrarily on a screen and the like of the cell phone P.

Further, in the video phone function of the video communication apparatus 1, communication routes are established with the plural video phones 31, 32 connected to a network or the like, and thereby video packets are received from the video phone 31 and the like via the LAN_I/F 16, decoded by the MPEG-2 codec 18 or the MPEG-4 codec 19, and displayed on the display 11 and the like. Furthermore, video/audio signals of the microphone 12 and the camera unit 13 are coded by the MPEG-2 codec 18 or the MPEG-4 codec 19, and sent to the video phones 31, 32 via the LAN_I/F 16, whereby the communication process of video phones is performed.

(Allocation Process)

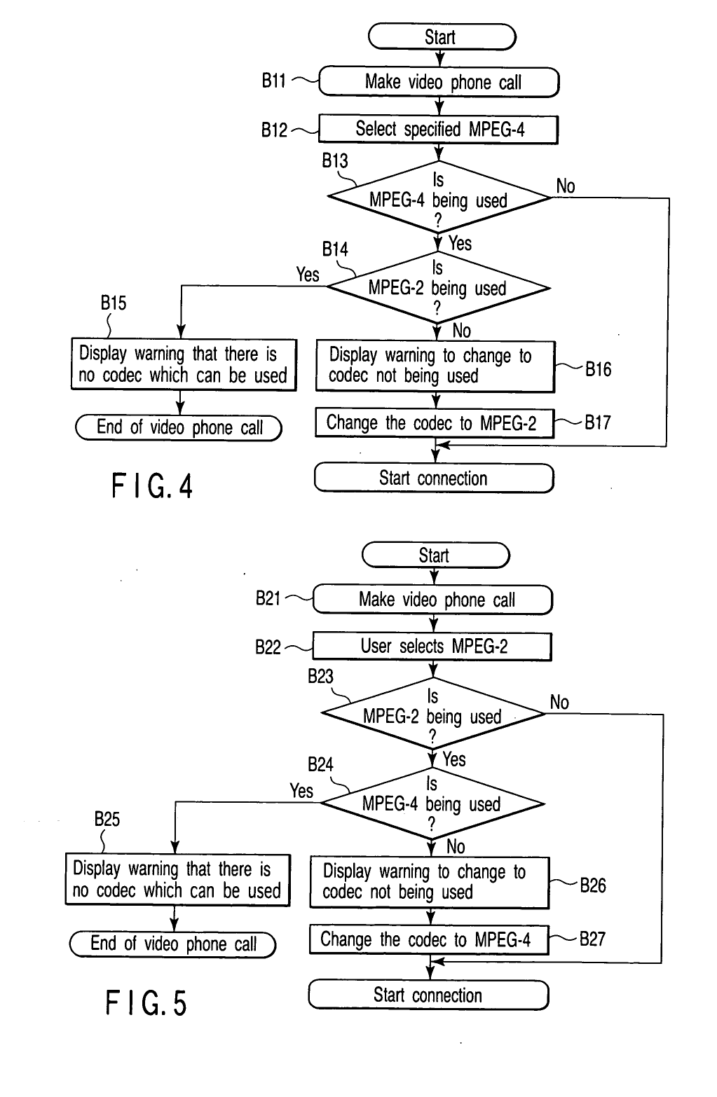

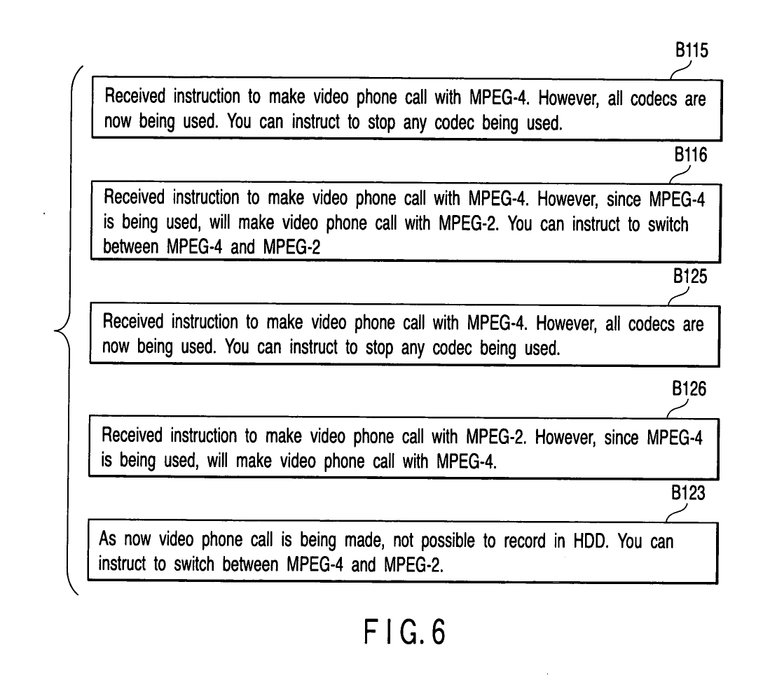

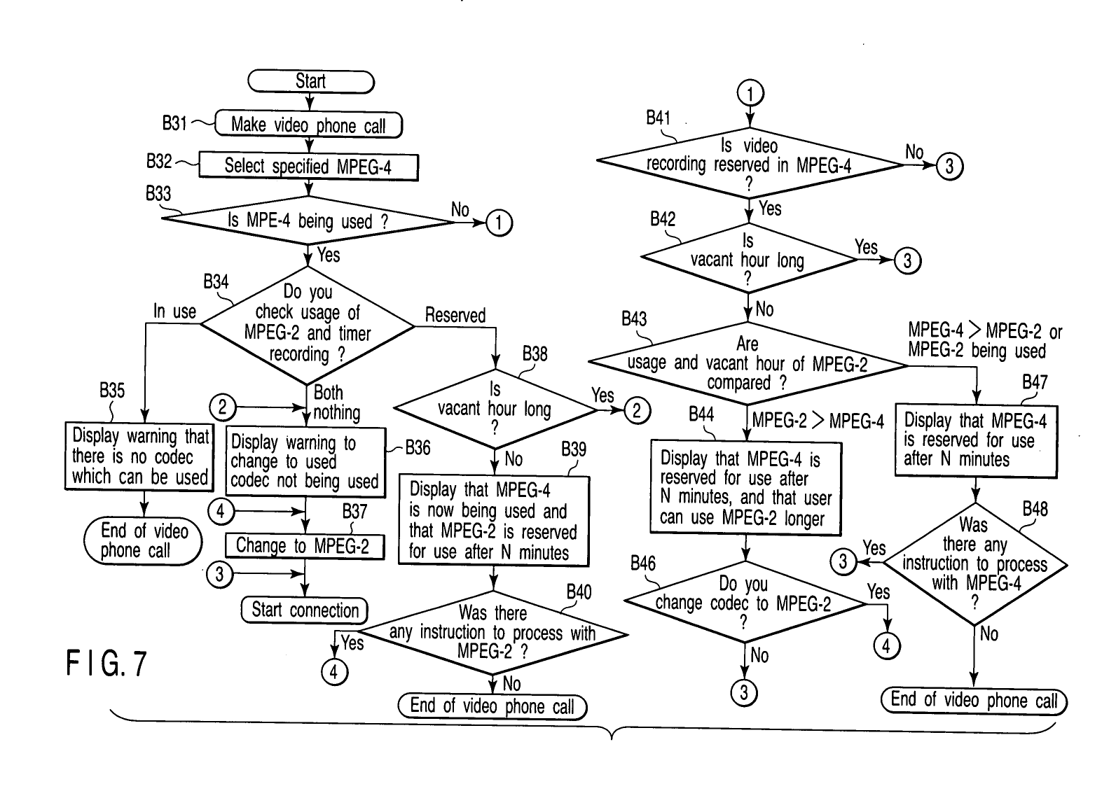

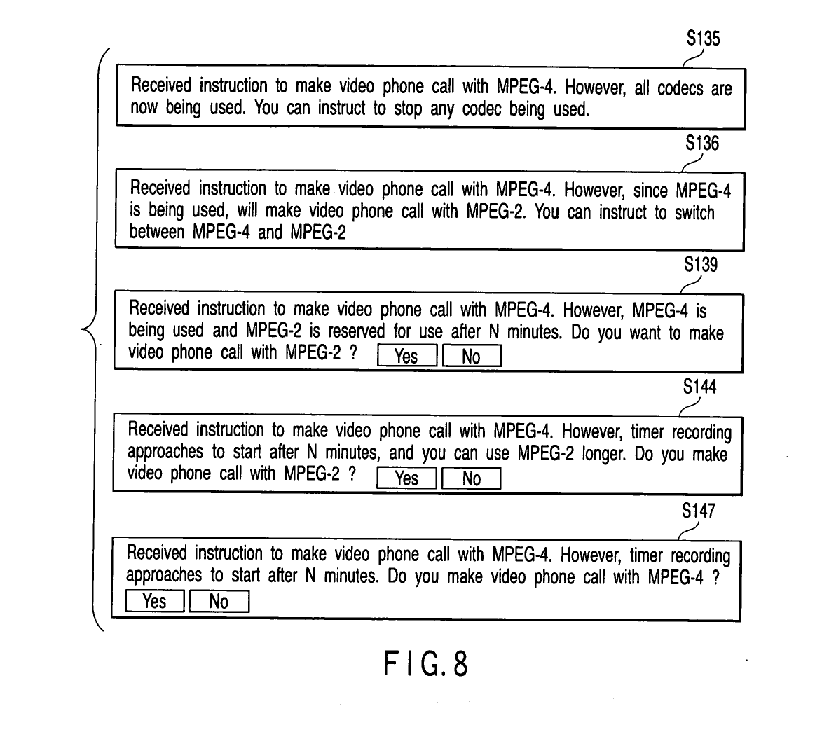

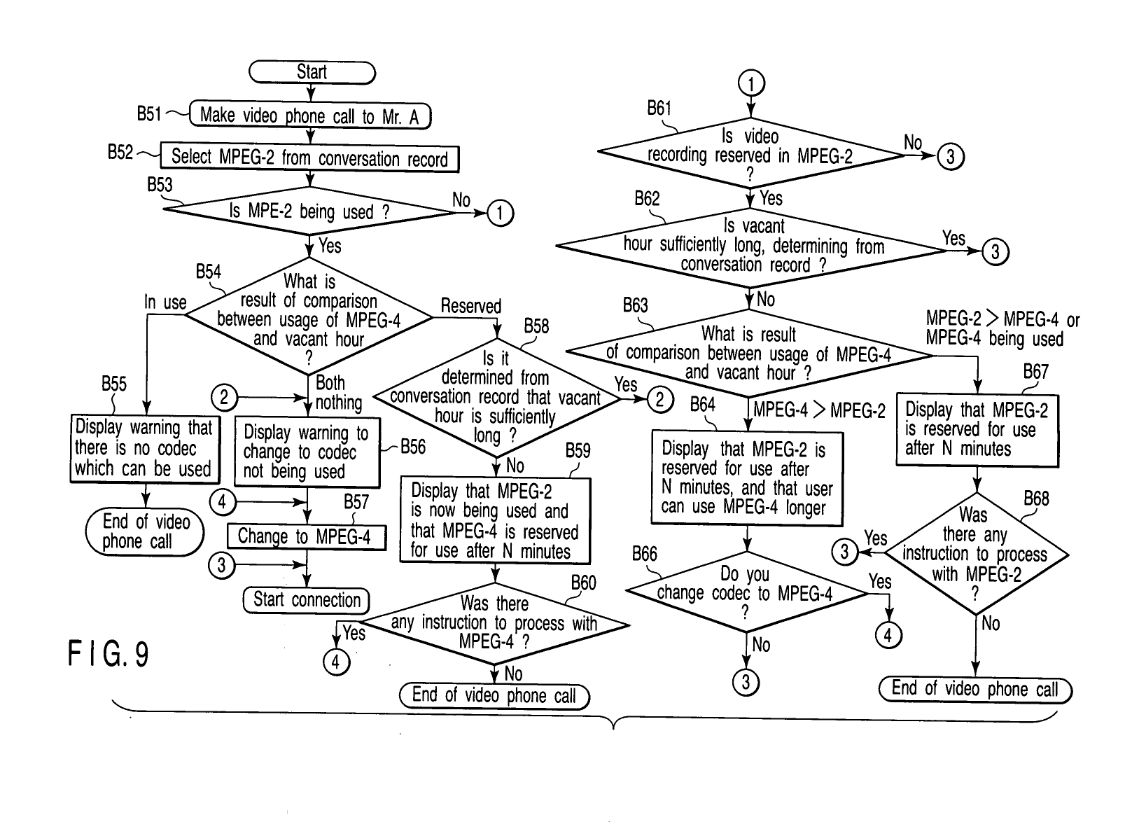

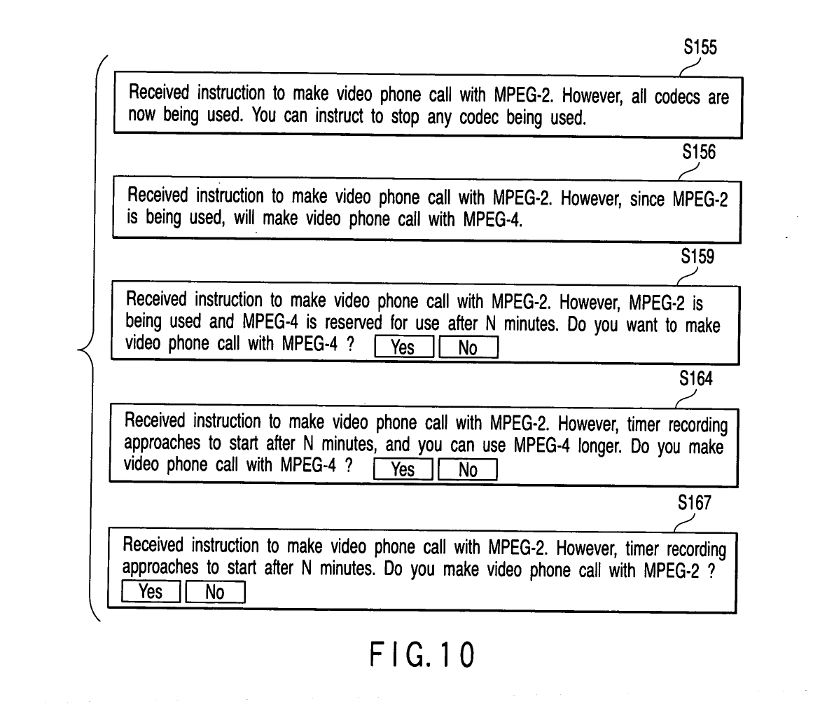

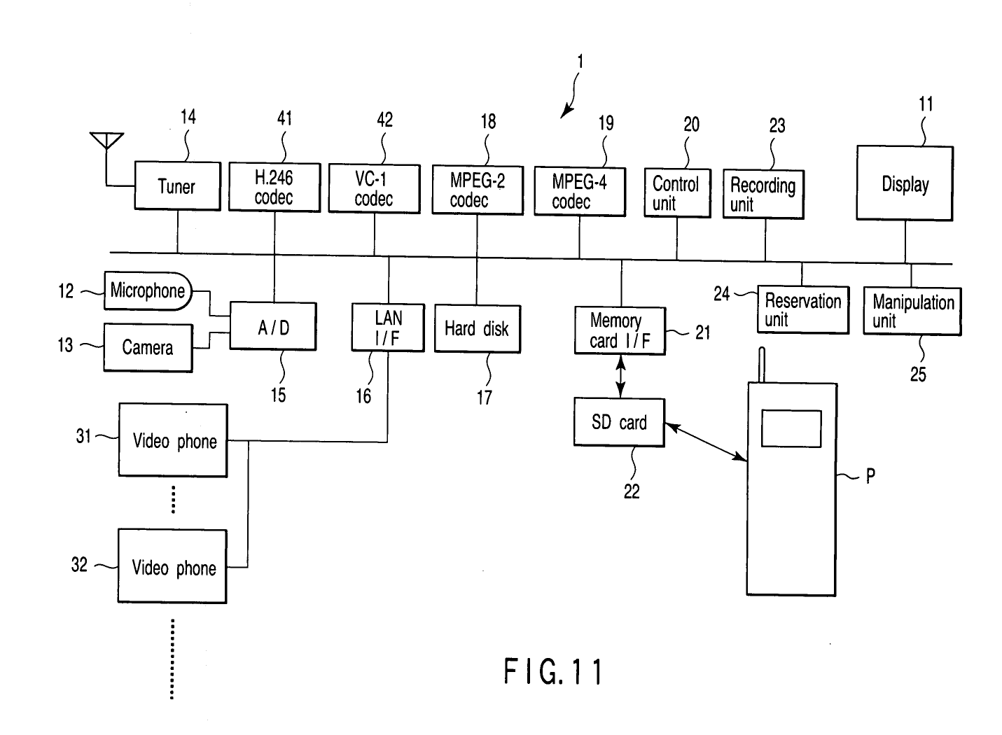

Next, with reference to flowcharts, an allocation process for plural codecs as the embodiment of the present invention will be explained hereinafter. FIG. 3 is an explanatory diagram showing an example of the relation between video processes and codecs in the video communication apparatus according to the embodiment of the invention. FIG. 4 is a flowchart showing an example of a process of selecting a codec in making a video phone call in MPEG-4 in the video communication apparatus according to the embodiment of the invention. FIG. 5 is a flowchart showing an example of a process of selecting a codec in making a video phone call in MPEG-2 in the video communication apparatus. FIG. 6 is a view showing an example of a message screen to be displayed in making a video phone call in MPEG-2 or MPEG-4 in the video communication apparatus. FIG. 7 is a flowchart showing an example of a process of selecting a codec in making a video phone call in MPEG-4 in consideration of reservation conditions in the video communication apparatus. FIG. 8 is a view showing an example of a message screen to be displayed in making a video phone call in MPEG-4 in consideration of reservation conditions in the video communication apparatus. FIG. 9 is a flowchart showing an example of a process of selecting a codec in making a video phone call in MPEG-2 in consideration of reservation conditions in the video communication apparatus. FIG. 10 is a view showing an example of a message screen to be displayed in making a video phone call in MPEG-2 in consideration of reservation conditions in the video communication apparatus. FIG. 11 is a block diagram showing another example of the configuration of the video communication apparatus.

<Allocation Process for Codecs in Video Communication Apparatus>

(Basic Allocation of Codecs)

The basic allocation of codecs in the video communication apparatus 1 as the embodiment of the present invention is shown in FIG. 3, and it is appropriate that the process of recording high quality video signals from, for example, the tuner 14 to the hard disk 17 and the like is allocated by the MPEG-2 (18). Further, it is appropriate that recording of video signals from the tuner 14 to the SD card 22 and the like, and the process of video phones are allocated by the MPEG-4 (19) whose information amount is smaller than that of the MPEG-2.

However, when codecs are allocated fixedly, the free degree of the operation is not assured, and usability of the user becomes fixed. Namely, for example, there is a case where communications in highly precise image quality are desired even in video phones. In addition, even when video signals are stored into the SD card, there is a case where video signals in high quality and highly dense image quality are demanded. For these cases, in the video communication apparatus 1 as the embodiment of the present invention, the user can select codecs arbitrarily as shown below.

(Video Phone: MPEG-4)

First, a case is supposed where the user designates the MPEG-4 codec to perform a video phone call. When the user manipulates the manipulation unit 25 and designates the MPEG-4 in order to make a video phone call (S11), the control unit 20 selects the MPEG-4 codec 19 in response to these manipulation signals (S12). At this moment, if the MPEG-4 has been used already, the control unit determines whether the MPEG-2 codec 18 is being used or not (S14). If the MPEG-2 codec 18 has been used already, the control unit determines that there is no codec which can be used, and displays on the display 11 and the like, the massage of S115 in FIG. 6 “Received instruction to make video phone call with MPEG-4. However, all codecs are now being used. You can instruct to stop any codec being used.” and the like (S15).

Further, if the MPEG-2 is not being used, the control unit displays on the display 11 and the like, the massage of S116 in FIG. 6 “Received instruction to make video phone call with MPEG-4. However, since MPEG-4 is being used, will make video phone call with MPEG-2. You can instruct to switch between MPEG-4 and MPEG-2.” and the like (S16). The control unit 24 changes the codec to the MPEG-2 codec 18 (S17).

As explained above, according to the video communication apparatus 1 as the embodiment of the present invention, if the codec that the user designates is given, or if the designated codec is being used, the message to that effect is displayed, and an codec which is not used (for example, MPEG-2) is selected automatically. Accordingly, it is possible to meet the user's request as much as possible. On the other hand, if the designated codec is being used, it is not forcibly terminated, and thereby it is possible to attain a well-balanced performance.

(Video Phone: MPEG-2)

Next, a case is supposed where the user designates the MPEG-2 codec to perform a video phone call. When the user manipulates the manipulation unit 25 and designates the MPEG-2 in order to make a video phone call (S21), the control unit 20 selects the MPEG-2 codec 18 in response to these manipulation signals (S22). At this moment, if the MPEG-2 has been used already, the control unit determines whether the MPEG-4 codec 19 is being used or not (S24). If the MPEG-4 codec 19 has been used already, the control unit determines that there is no codec which can be used, and displays on the display 11 and the like, the massage of S125 in FIG. 6 “Received instruction to make video phone call with MPEG-2. However, all codecs are now being used. You can instruct to stop any codec being used.” and the like (S25).

Further, if the MPEG-4 is not being used, the control unit displays on the display 11 and the like, the massage of S126 in FIG. 6 “Received instruction to make video phone call with MPEG-2. However, since MPEG-2 is being used, will make video phone call with MPEG-4. You can instruct to switch between MPEG-2 and MPEG-4.” and the like (S26). The control unit 24 changes the codec to the MPEG-4 codec 19 (S27).

Meanwhile, if the MPEG-2 is selected in step S23, it is preferable to display the message of S123 in FIG. 6 “As now video phone call is being made by MPEG-2, not possible to record in HDD. You can instruct to switch between MPEG-4 and MPEG-2.” and the like.

As explained above, according to the video communication apparatus 1 as the embodiment of the present invention, it is possible to attain a well-balanced performance according to the user's request and the codec use conditions, in the same manner as in the previous case.

(Video Phone: MPEG-4: with Reservation)

Next, the user designates the MPEG-4 codec to perform a video phone call, and a case where timer recording has been set to this codec will be explained with reference to the flowchart in FIG. 7 hereinafter.

First, a case is supposed where the user designates the MPEG-4 codec to perform a video phone call. When the user manipulates the manipulation unit 25 and designates the MPEG-4 in order to make a video phone call (S31), the control unit 20 selects the MPEG-4 codec 19 in response to these manipulation signals (S32). At this moment, if the MPEG-4 has been used already, the control unit checks whether the MPEG-2 codec 18 is being used or not and whether there is timer recording reserved or not (S34). If the MPEG-2 codec 18 has been used already, the control unit determines that there is no codec which can be used, and displays on the display 11 and the like, the massage of S135 in FIG. 8 “Received instruction to make video phone call with MPEG-4. However, all codecs are now being used. You can instruct to stop any codec being used.” and the like (S35).

Further, if the MPEG-2 is not being used, and there is not timer recording reserved, the control unit displays on the display 11 and the like, the massage of S136 in FIG. 8 “Received instruction to make video phone call with MPEG-4. However, since MPEG-4 is being used, will make video phone call with MPEG-2. You can instruct to switch between MPEG-4 and MPEG-2.” and the like (S36). The control unit 24 changes the codec to the MPEG-2 codec 18 (S37).

Meanwhile, if there is timer recording reserved with regard to the MPEG-2, it is determined whether there is a predetermined time (for example, 30 minutes or more) before the timer recording or not (S38). If there is not sufficient vacant time, the control unit displays a message that the MPEG-4 is now being used and the MPEG-2 is reserved for use after N minutes (for example 15 minutes) (S39).

Namely, as shown in step S139 in FIG. 8, the control unit displays a message “Received instruction to make video phone call with MPEG-4. However, since MPEG-4 is being used, and MPEG-2 is reserved for use after N minutes. Do you want to make video phone call with MPEG-2?” (S39). Herein, if “Yes” is selected to the question whether the user wants to make a video phone call with MPEG-2, the process goes on to the step S37, the codec is changed to MPEG-2, and connection is started. If “No” is selected, the process ends without connecting the video phone.

Further, if there is sufficiently long vacant time in step S38, the process goes on to the step S36, and the display of the above S136 message (S36). Then, the codec is changed to MPEG-2 (S37), and connection is started.

Furthermore, if the MPEG-4 is not being used in step S33, the control unit checks whether there is timer recording reserved to the MPEG-4 or not (S41). If there is timer recording, the control unit uses the MPEG-4 codec as it is, and starts connection of the video phone.

Herein, if there is sufficiently long vacant time (for example, 30 minutes or more) even when it is determined that there is timer recording reserved in the MPEG-4 (S42), the control unit uses the MPEG-4 codec as it is, and starts connection of the video phone.

If there is not sufficient vacant time in step S42 (S42), the use conditions and vacant time of the MPEG-2 are compared with those of the MPEG-4 (S43). Then, if it stands that MPEG-2>MPEG-4 (the vacant time of the MPEG-2 is longer than that of the MPEG-4), to the effect that the MPEG-4 has a reservation after N minutes and further, the MPEG-2 can be used longer, the control unit displays, in step S144 in FIG. 8, a message “Received instruction to make video phone call with MPEG-4. However, timer recording approaches to start after N minutes, and you can use MPEG-2 longer. Do you make video phone call with MPEG-2?” (S44).

Then, if there is an indication of the user's intention to change the codec to the MPEG-2 (S46), the process goes on to the step S37, in which the codec is changed and connection is started (S37).

If it stands that MPEG-4>MPEG-2 (the vacant time of the MPEG-4 is longer than that of the MPEG-2), or if the MPEG-2 is being used in step S43, to the effect that the MPEG-4 has a reservation after N minutes, the control unit displays, in step S147 in FIG. 8, a message “Received instruction to make video phone call with MPEG-4. However, timer recording approaches to start after N minutes. Do you make video phone call with MPEG-4?” (S47). Then, if there is an instruction to do with the MPEG-4 (S48), connection is started. Meanwhile, if there is no instruction, the use of the video phone is ended.

Meanwhile, in step S46, it is also preferable to start the connection automatically without asking the user's intention.

(Video Phone: MPEG-2: with Reservation)

Next, the user designates the MPEG-2 codec to perform a video phone call, and a case where timer recording has been set to this codec will be explained with reference to the flowchart in FIG. 9 hereinafter.

First, a case is supposed where the user designates the MPEG-2 codec to perform a video phone call. When the user manipulates the manipulation unit 25 and designates the MPEG-2 in order to make a video phone call (S51), the control unit 20 selects the MPEG-2 codec 18 in response to these manipulation signals (S52). At this moment, if the MPEG-2 has been used already, the control unit checks whether the MPEG-4 codec 19 is being used or not and whether there is timer recording reserved or not (S54). If the MPEG-4 codec 19 has been used already, the control unit determines that there is no codec which can be used, and displays on the display 11 and the like, the massage of S155 in FIG. 10 “Received instruction to make video phone call with MPEG-2. However, all codecs are now being used. You can instruct to stop any codec being used.” and the like (S55).

Further, if the MPEG-4 is not being used, and there is not timer recording reserved, the control unit displays on the display 11 and the like, the massage of S156 in FIG. 8 “Received instruction to make video phone call with MPEG-2. However, since MPEG-2 is being used, will make video phone call with MPEG-4. You can instruct to switch between MPEG-2 and MPEG-4.” and the like (S56). The control unit 24 changes the codec to the MPEG-4 codec 19 (S57).

If there is timer recording reserved with regard to the MPEG-4, it is determined whether there is a predetermined time (from the past communication time, for example, 30 minutes or more) before the timer recording or not (S58). If there is not sufficient vacant time, the control unit displays a message that the MPEG-2 is now being used and the MPEG-4 is reserved for use after N minutes (for example 15 minutes) (S59).

Namely, as shown in step S159 in FIG. 10, the control unit displays a message “Received instruction to make video phone call with MPEG-2. However, since MPEG-2 is being used, and MPEG-4 is reserved for use after N minutes. Do you want to make video phone call with MPEG-4?” (S59). Herein, if “Yes” is selected to the question whether the user wants to make a video phone call with MPEG-4, the process goes on to the step S57, in which the codec is changed to MPEG-4 and connection is started. If “No” is selected, the process ends without connecting the video phone.

Further, if there is sufficiently long vacant time in step S58, the process goes on to the step S56, and the display of the above S156 message (S56). Thereafter, the codec is changed to MPEG-4 (S57), and connection is started.

Furthermore, if the MPEG-2 is not being used in step S53, the control unit checks whether there is timer recording reserved to the MPEG-2 or not (S61). If there is timer recording, the control unit uses the MPEG-2 codec as it is, and starts connection of the video phone.

Herein, if there is sufficiently long vacant time (for example, from the past communication time, 30 minutes or more) even when it is determined that there is timer recording reserved in the MPEG-2 (S62), the control unit uses the MPEG-2 codec as it is, and starts connection of the video phone.

If there is not sufficient vacant time in step S62 (S62), the use conditions and vacant time of the MPEG-4 are compared with those of the MPEG-2 (S63). Then, if it stands that MPEG-4>MPEG-2 (the vacant time of the MPEG-4 is longer than that of the MPEG-2), to the effect that the MPEG-2 has a reservation after N minutes, and further, the MPEG-4 can be used longer, the control unit displays, in step S164 in FIG. 10, a message “Received instruction to make video phone call with MPEG-2. However, timer recording approaches to start after N minutes, and you can use MPEG-4 longer. Do you make video phone call with MPEG-4?” (S64).

Then, if there is an indication of the user's intention to change the codec to the MPEG-4 (S66), the process goes on to the step S57, in which the codec is changed and connection is started (S57).

If it stands that MPEG-2>MPEG-4 (the vacant time of the MPEG-2 is longer than that of the MPEG-4), or if the MPEG-4 is being used in step S63, to the effect that the MPEG-2 has a reservation after N minutes, the control unit displays, in step S167 in FIG. 10, a message “Received instruction to make video phone call with MPEG-2. However, timer recording approaches to start after N minutes. Do you make video phone call with MPEG-2?” (S67). Then, if there is an instruction to do with the MPEG-2 (S68), connection is started, meanwhile if there is not an instruction, the use of the video phone is ended.

Meanwhile, in step S66, it is also preferable to start the connection automatically without asking the user's intention.

As explained above, according to the video communication apparatus 1 as the embodiment of the present invention, the codec that the user designates is given. Or, if the designated codec is being used, the message to that effect is displayed, and a codec which is not used (for example, MPEG-2) is selected automatically. Further, processing is performed in consideration of timer recording reserved in codecs. Accordingly, it is possible to meet the user's request as much as possible. On the other hand, if the designated codec is being used, it is not forcibly terminated, and thereby it is possible to attain a well-balanced performance.

(Receiving Broadcasting, and the Like)

In the above flowcharts, the case where a video phone call is made in the video communication apparatus 1 as the embodiment of the present invention has been explained. However, the same process may be applied to the case to receive broadcasting signals by use of the tuner unit, the case to arrange timer recording, and the case to record video information and the like to recording media including an SD card and the like.

Further, in addition to the above-described case of the MPEG-2 codec 18 and the MPEG-4 codec 19, other various embodiments for plural codecs may be available. Namely, with regard to plural codecs, for example, at least a case of an H. 264 codec 41 and a case of a VC-1 codec 42 may be available as shown in the block diagram of another embodiment in FIG. 11.

Namely, as shown in FIG. 11, four kinds of codecs may be employed together, or simply, the H. 264 codec may be employed in the place of the MPEG-4 codec 19, and all the combinations may be available in the same manner.

(Other Messages)

In addition, by the operation of the control unit 20, many cases are supposed where desired codecs are selected, and useful messages for the user are displayed, in consideration of the use conditions of plural codecs. Representative cases are explained in order hereinafter.

—Timer Recording Countermeasure 1

In a video communication apparatus, there may be a case where a video phone call is to be made by the MPEG-2, and the MPEG-4 is already being used by the SD card. In this case, the user may select the vacant codec. However, recording cannot be made if the user forgets to reserve timer recording, or a video phone does not stop even if the user remembers timer recording, or, recording will start after 20 minutes, so that the user is unable to make a decision. As a method to avoid such a problem, it is preferable to take a method to switch to the vacant codec by the operation of the control unit 20 several minutes prior to the start of recording during communications.

—Timer Recording Countermeasure 2

As a timer recording countermeasure, as a method to minimize session disconnections, it is preferable to take a method where the control unit 20 monitors the reservation time, and for example 10 minutes prior to the start of timer recording, the display 11 or the like prompts the user to switch the phone from the MPEG-2 to the MPEG-4. Consequently, the phone session will not be disconnected against the user's will.

—Use of Call Partner List

In the operation of the control unit 20, a call partner list of the communication unit 16 is prepared beforehand, and attributes of each call partner are recorded per parameter. It is preferable to automatically and selectively use, for example, the MPEG-2 codec, and the MPEG-4 codec according to each call partner. It is preferable to use the MPEG-4 even about 30 minutes before timer recording for a call to Mr. A because he likes to talk too long, and use the MPEG-2 even 10 minutes before Mr. B because he talks short, and the like. Further, according to this call partner list, it is preferable to display various warning screens and the like according to the operation of the control unit 20, and thereby offer a convenient operation for the user.

—Countermeasure During Use of Codec

In the operation of the control unit 20, it is preferable to make a control to perform only audio communications without using video when the codec designated for video communications is being used.

Further, in the operation of the control unit 20, in the case where the designated codec is being used in performing the process of decoding video/audio signals of broadcasting signals by use of the tuner unit, it is preferable to make a control to the codec that is now being used as well by reducing a frame rate of video/audio signals, or reducing an image size.

Furthermore, in the same manner, in the case where a necessary codec cannot be used because video communications are now made with an external device in performing the process of decoding video/audio signals of broadcasting signals by use of the tuner unit, it is preferable to make a control not to perform the process of decoding video/audio signals of broadcasting signals, but to record them into the recording area in the hard disk or the like.

—Timer Recording Countermeasure

Further, it is a preferable control for the control unit 20, when timer recording approaches to a predetermined time (10 minutes or the like) and more in the case where a codec now being used for video communications is to be used for timer recording, to prompt the user to switch codecs for timer recording on the display or the like.

It may be well understood by those skilled in the art that each of the embodiments mentioned above includes various modifications of the invention, and by appropriate combinations of plural structural components disclosed in each of the embodiments, it is possible to extract various stages of invention, which is apparent to those skilled in the art. Accordingly, the present invention is not limited to the above embodiments, but the present invention may be embodied by appropriately modifying the structural elements thereof without departing from the spirit or essential characteristics thereof.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video communication apparatus comprising:
a display unit which receives decoded signals from at least one of a first codec and a second codec and displays video corresponding to the signals; and
a control unit which performs a control so as to designate one of the first codec and the second codec and receive an instruction to perform video communications by video/audio signals with an external device by use of a communication unit, or, designate one of the first codec and the second codec and receive an instruction to perform a process of decoding video/audio signals of broadcasting signals by use of a tuner unit; and perform the instructed process by the designated codec of the first codec and the second codec; and in the case where the designated codec is already being used, perform the instructed process by use of the codec that is not being used, and display a message to the effect that the other codec than the designated one is being used.

2. A video communication apparatus according to claim 1, wherein audio signals from a microphone and video signals from a camera unit are supplied to the communication unit, and video communications as a video phone are performed with the external device.

3. A video communication apparatus according to claim 1, wherein the control unit performs a control so as to display a message to the effect that, since the first codec is now being used in the video communications, the process of reproducing the video/audio signals from the tuner unit is not performed.

4. A video communication apparatus according to claim 1, wherein the control unit performs a control so as to prompt its user to switch the first codec or the second codec now being used.

5. A video communication apparatus according to claim 1, wherein the control unit performs a control so as to display a message to the effect that there is a program reservation to be made by use of the designated first codec or second codec.

6. A video communication apparatus according to claim 1, wherein the control unit performs a control so as to select the first codec or the second codec, or, to display a warning in accordance with a call partner list of communications using the communication unit.

7. A video communication apparatus according to claim 1, wherein the control unit performs a control so as to perform only audio communications without using video when the codec designated for the video communications is now being used.

8. A video communication apparatus according to claim 1, wherein the control unit performs a control so as, in the case where the designated codec is being used in performing the process of decoding the video/audio signals of the broadcasting signals by use of the tuner unit, to use the codec now being used as well by reducing a frame rate of the video/audio signals, or reducing an image size.

9. A video communication apparatus according to claim 1, wherein the control unit performs a control so as, in the case where a necessary codec is not usable because video communications are now made with the external device in performing the process of decoding the video/audio signals of the broadcasting signals by use of the tuner unit, not to perform the process of decoding the video/audio signals of the broadcasting signals, but to record them into a recording area.

10. A video communication apparatus according to claim 1, wherein the control unit performs a control so as, when timer recording approaches to a predetermined time and more in the case where the codec now being used for video communications is to be used for timer recording, to prompt the user to switch codecs for timer recording.

11. A video communication method using a first codec for decoding video/audio signals by communications with an external device or video/audio signals obtained by demodulating broadcasting signals, and a second codec that is different from the first codec, the method comprising:
designating one of the first codec and the second codec and receiving an instruction to perform video communications with the external device, or, designating one of the first codec and the second codec and receiving an instruction to perform a process of decoding the video/audio signals obtained by demodulating the broadcasting signals; and performing the instructed process by the designated codec of the first codec and the second codec; and in the case where the designated codec is already being used, performing the instructed process by use of the codec that is not being used, and displaying a message to the effect that the other codec than the designated one is being used.

12. A video communication method according to claim 11, wherein audio signals from a microphone and video signals from a camera unit are coded by use of one of the first codec and the second codec, and video communications as a video phone are performed with the external device by use of the coded signals.

13. A video communication method according to claim 11, wherein, since a control is performed so as to display a message to the effect that the first codec is now being used in the video communications, the process of reproducing the video/audio signals from the tuner is performed.

14. A video communication method according to claim 11, wherein a control is performed so as to prompt its user to switch the first codec or the second codec now being used.

15. A video communication method according to claim 11, wherein a control is performed so as to display a message to the effect that there is a program reservation to be made by use of the designated first codec or second codec.

16. A video communication method according to claim 11, wherein a control is performed so as to select the first codec or the second codec, or, display a warning in accordance with a call partner list of communications using the communication unit.

17. A video communication method according to claim 11, wherein a control is performed so as to perform only audio communications without using video when the codec designated for the video communications is now being used.

18. A video communication method according to claim 11, wherein a control is performed so as, in the case where the designated codec is being used in performing the process of decoding the video/audio signals of the broadcasting signals, to use the codec now being used as well by reducing a frame rate of the video/audio signals, or reducing an image size.

19. A video communication method according to claim 11, wherein a control is performed so as, in the case where a necessary codec cannot is not usable because video communications are now made with the external device in performing the process of decoding the video/audio signals of the broadcasting signals, not to perform the process of decoding the video/audio signals of the broadcasting signals, but to record them into a recording area.

20. A video communication method according to claim 11, wherein a control is performed so as, when timer recording approaches to a predetermined time and more in the case where the codec now being used for video communications is to be used for timer recording, to prompt the user to switch codecs for timer recording.
